(19) United States
(12) Patent Application Publication
(10) Pub. No.: US 2009/0301266 A1
(43) Pub. Date: Dec. 10, 2009

(54) Switch Device for Ratchet Wrench

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/412,422

(22) Filed: Mar. 27, 2009

(30) Foreign Application Priority Data
Jun. 10, 2008 (TW) 97121530

(51) Int. Cl. B25B 13/46

(52) U.S. Cl. 81/62

(57) ABSTRACT

A ratchet wrench includes a head (11) having a through-hole (13) rotatably receiving a drive member (20). A pawl (30) is pivotably received in a compartment (22) in the drive member (20). A switch member (42) is rotatably mounted to an end (54) of the drive member (20). A control member (41) is received in the drive member (20) and movable relative to the switch member (42) and the drive member (20) between a coupling position and a release position. When the control member (41) is in the coupling position, the switch member (42) and the control member (41) are rotatable relative to the drive member (20) between two operative positions, and a socket can be engaged with the other end (56) of the drive member (20). The socket can be removed from the other end (56) of the drive member (20) when the control member (41) is in the release position.

### BACKGROUND OF THE INVENTION

The present invention relates to a switch device and, more particularly, to a switch device for a ratchet wrench.

Taiwan Patent Publication No. 235541 entitled “IMPROVED RATCHET WRENCH STRUCTURE” discloses a ratchet wrench including two pawls pivotably mounted in a pivotal rod receiving two balls. A spring-biased push rod is extended through the pivotal rod and includes an enlarged head on an end thereof and a recessed portion in the other end thereof. A socket engaging ball is received in the recessed portion. Each pawl includes an inner side having a groove with two faces. Each ball is biased to selectively press against one of the faces of one of the pawls. Such a ratchet wrench can engage with a socket to drive fasteners such as bolts, nuts, etc. in one of two operative directions while allowing free rotation in a reverse direction. When the enlarged head of the push rod is pressed, the socket engaging ball can be received in the recessed portion to allow removal of the socket from the ratchet wrench. However, the enlarged head is liable to be inadvertently pressed when using the ratchet wrench in a small space, leading to undesired disengagement of the socket. Furthermore, the diameter difference between the enlarged head and the remaining portion of the push rod is so large that a large amount of material is wasted while manufacturing the push rod by milling. The time for processing is long, and the costs are high. Furthermore, stress concentration occurs in the adjoining area between the enlarged head and the remaining portion of the push rod, such that the push rod may break at the adjoining area.

Thus, a need exists for a ratchet wrench that has a stronger structure and that allows reliable operation in a small space.

### BRIEF SUMMARY OF THE INVENTION

The present invention solves this need and other problems in the field of reliable operation of wrenches in a small space by providing, in a preferred form, a ratchet wrench including a head and a handle interconnected to the head. The head includes first and second sides spaced in a thickness direction. The head further includes a through-hole extending from the first side through the second side and having an inner periphery with a plurality of teeth. A drive member is rotatably received in the through-hole and includes first and second ends spaced in the thickness direction. The first end of the drive member includes a compartment. The drive member further includes a hole extending in the thickness direction and in communication with the compartment. The second end of the drive member includes a transverse hole extending in a radial direction perpendicular to the thickness direction and receiving a ball adapted for coupling with a socket. A pawl is pivotably received in the compartment. The pawl includes first and second ends and an inner side extending between the first and second ends in a longitudinal direction perpendicular to the thickness direction. The first end of the pawl includes a plurality of first teeth, and the second end of the pawl includes a plurality of second teeth. The inner side of the pawl includes first and second positioning faces. A switch member is rotatably mounted to the first end of the drive member and includes an engaging hole. A control member is rotatably received in the hole of the drive member between first and second operative positions. The control member is movable in the thickness direction relative to the switch member and the drive member between a coupling position and a release position. A spring is mounted between the control member and the drive member to bias the control member to the coupling position. The control member includes a first end having an engaging portion. The control member further includes a second end having a recessed portion spaced from the engaging portion in the thickness direction. The recessed portion receives the ball. A pressing device is mounted in the control member and includes an elastic element and a pressing member biased by the elastic element to press against one of the first and second positioning faces of the pawl with the plurality of first teeth or the plurality of second teeth engaged with the plurality of teeth of the head corresponding to the first and second operative positions of the control member.

When the control member is in the coupling position, the engaging portion of the control member is engaged in the engaging hole of the switch member allowing joint rotation of the switch member and the control member relative to the drive member between the first and second operative positions, and the first ball is biased by the recessed portion to protrude out of the transverse hole for coupling with the socket. On the other hand, when the control member is in the release position, the ball is movable in the radial direction into the recessed portion, allowing removal of the socket from the second end of the drive member.

In a preferred form, the switch member includes inner and outer sides spaced in the thickness direction. The engaging hole extends from the inner side through the outer side. The switch member further includes a recess in the inner side, forming a peripheral wall having an outer diameter larger than the through-hole of the head. The inner side of the peripheral wall rotatably abuts the first side of the head. The peripheral wall of the switch member further includes an inner periphery having a groove. The peripheral wall further includes a notch in communication with the groove of the switch member. The first end of the drive member includes an annular groove in an outer periphery thereof. A retainer ring is received in the groove of the switch member and in the annular groove of the drive member. The retainer ring includes two tangs received in the notch of the peripheral wall and abutting two end faces of the notch.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a perspective view of a ratchet wrench of an embodiment according to the preferred teachings of the present invention.

FIG. 2 shows an exploded, perspective view of the ratchet wrench of FIG. 1.

FIG. 3 shows a bottom, perspective view of a switch member of the ratchet wrench of FIG. 1.

FIG. 4 shows a cross sectional view of the ratchet wrench of FIG. 1 according to section line 4-4 of FIG. 1.

FIG. 5 shows a cross sectional view of the ratchet wrench of FIG. 1 according to section line 5-5 of FIG. 1.

FIG. 6 is a view similar to FIG. 4 with a control member pressed.

FIG. 7 shows an exploded, perspective view of a ratchet wrench of another embodiment according to the preferred teachings of the present invention.

FIG. 8 shows a cross sectional view of the ratchet wrench of FIG. 7.

FIG. 9 shows a partial, cross sectional view of the ratchet wrench of FIG. 1 with the control member in a first operative position.

FIG. 10 is a view similar to FIG. 9, wherein the control member is in a second operative position.

FIG. 11 shows a partial, cross sectional view of the ratchet wrench of FIG. 7 with the control member in a first operative position.

FIG. 12 is a view similar to FIG. 11, wherein the control member is in a second operative position.

FIG. 13 shows a bottom, perspective view of a switch member of the ratchet wrench of FIG. 7.

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “fourth”, “inner”, “outer”, “side”, “end”, “portion”, “section”, “annular”, “radial”, “longitudinal”, “clockwise”, “counterclockwise”, “thickness”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

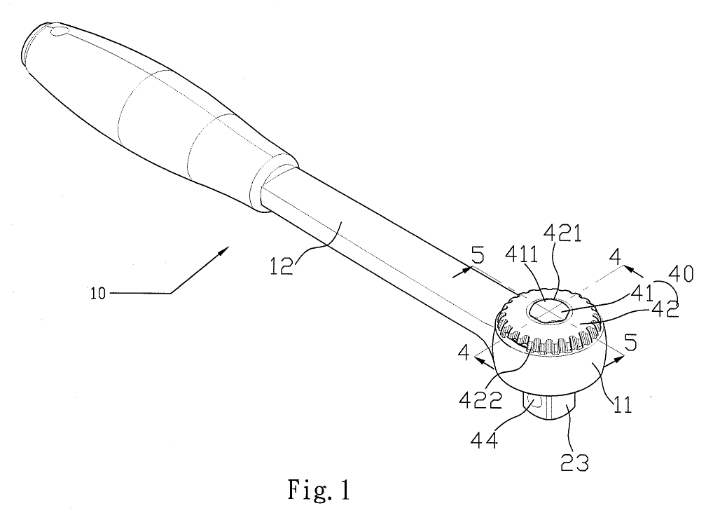

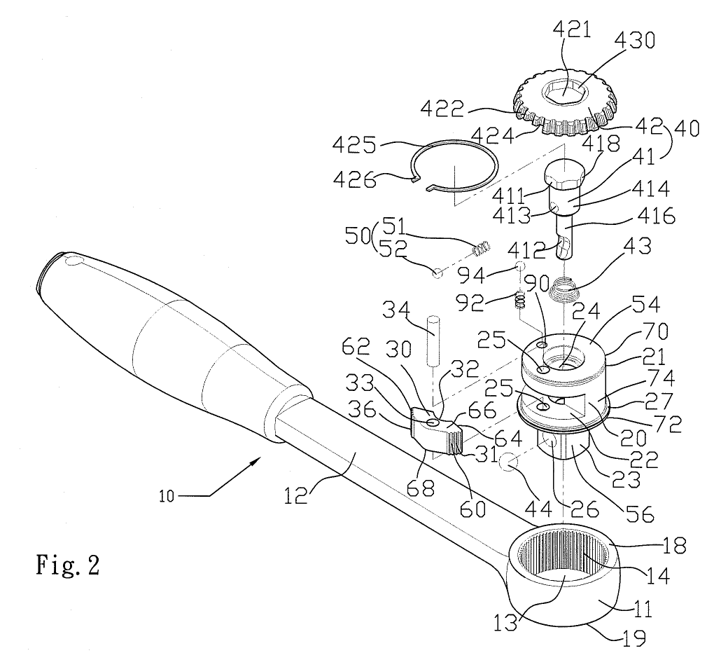

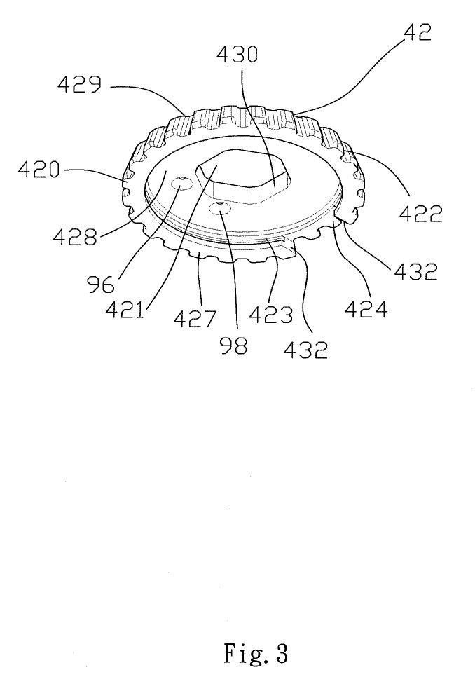

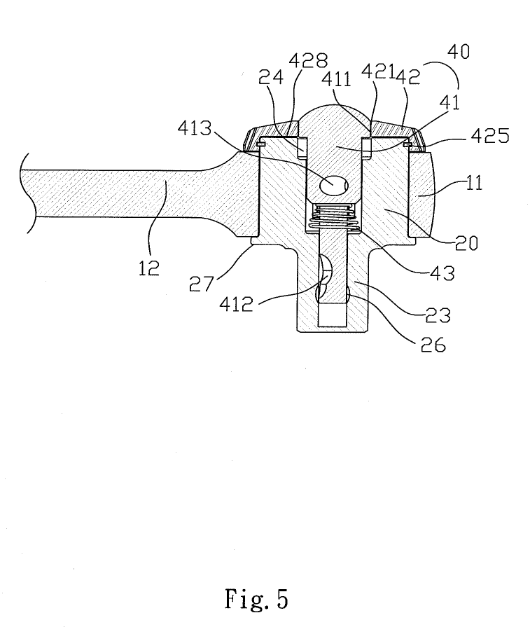

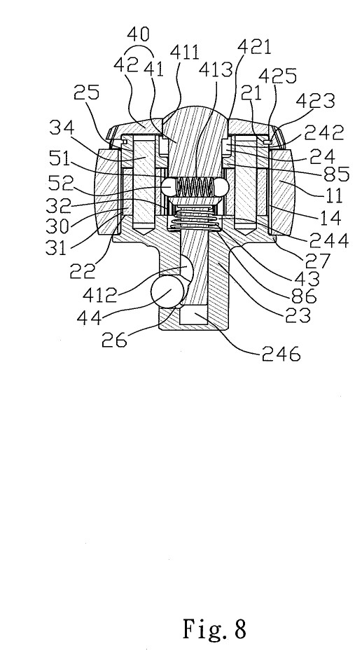

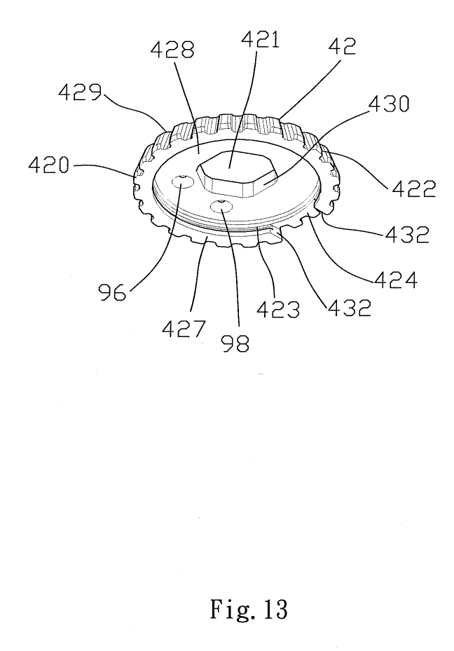

A ratchet wrench according to the preferred teachings of the present invention is shown in the drawings and generally includes a body 10 having a head 11 and a handle 12 interconnected to head 11. In preferred forms shown in FIGS. 1-13, head 11 includes circular cross sections and first and second sides 18 and 19 spaced in a thickness direction. Head 11 further includes a through-hole 13 extending from first side 18 through second side 19. Through-hole 13 includes an inner periphery having a plurality of teeth 14 extending in the thickness direction.

In the preferred forms shown in FIGS. 1-13, a drive member 20 is rotatably received in through-hole 13. Drive member 20 includes first and second ends 54 and 56 spaced in the thickness direction. First end 54 includes first and second boards 70 and 72 spaced in the thickness direction and an interconnecting wall 74 interconnected between first and second boards 70 and 72. First board 70 includes an annular groove 21 in an outer periphery thereof Second board 72 includes a flange 27 on an outer periphery thereof Flange 27 rotatably abuts second side 19 of head 11. Furthermore, first end 54 of drive member 20 includes a hole 24 extending in the thickness direction from first end 54 to second end 56.

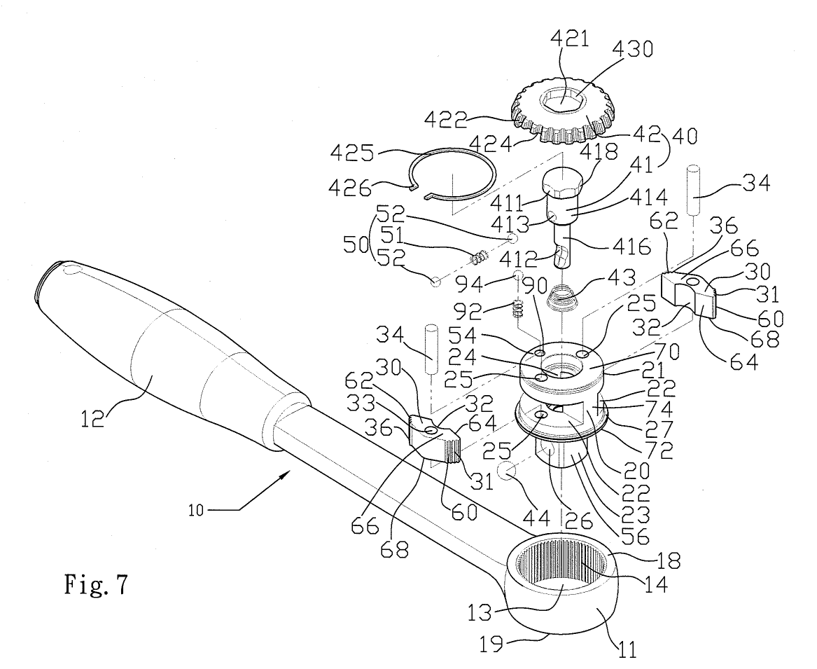

In the preferred form shown in FIGS. 1-6 and 9-10, first end 54 of drive member 54 includes a compartment 22 between first and second boards 70 and 72 and in communication with hole 24. Furthermore, first and second boards 70 and 72 include two aligned first pivot holes 25 in communication with compartment 22. In the preferred form shown in FIGS. 7-8 and 11-13, first end 54 of drive member 54 includes two compartments 22 between first and second boards 70 and 72 and in communication with each other via hole 24. Furthermore, first and second boards 70 and 72 includes two aligned second pivot holes 25 diametrically opposite to first pivot holes 25 and in communication with second compartment 22. Further, first end 54 includes a receptacle 90 extending in the thickness direction from first board 70 into interconnecting wall 74 and receiving a spring 92 and a ball 94.

In the preferred forms shown in FIGS. 1-13, hole 24 includes a first stepped portion 85 in first board 70 and a stepped portion 86 in second board 72, dividing hole 24 into first, second, and third sections 242, 244, and 246 from first end 54 to second end 56 of drive member 20, with first section 242 having a diameter larger than that of second section 244, which in turn, is larger than that of third section 246. Furthermore, second end 56 of drive member 20 is in the form of a drive column 23 located outside of head 11 and having square cross sections. Second end 56 of drive member 20 includes a transverse hole 26 receiving a ball 44 and in communication with third section 246 of hole 24. Drive column 23 can be releasably coupled with a socket for driving a fastener. Other forms of second end 56 of drive member 20 for directly or indirectly engaging with a fastener to be loosened or tightened would be within the skill of the art.

In the preferred form shown in FIGS. 1-6 and 9-10, a pawl 30 is pivotably received in compartment 22. Pawl 30 includes first and second ends 60 and 62 and an inner side 64 extending between first and second sides 60 and 62 in a longitudinal direction perpendicular to the thickness direction. First end 60 of pawl 30 includes a plurality of first teeth 31, and second end 62 of pawl 30 includes a plurality of second teeth 32. Inner side 64 of pawl 30 includes a positioning section 32 in the preferred form shown as an arcuate groove having first and second positioning faces 321 and 322 spaced in the longitudinal direction. Pawl 30 further includes upper and lower faces 66 and 68 spaced in the thickness direction and a pin hole 33 extending from upper face 66 through lower face 68. A pin 34 is extended through pivot holes 25 of drive member 20 and pin hole 33 of pawl 30 and defines a pivot axis about which pawl 30 is pivotable. In the preferred form shown in FIGS. 7-8 and 11-13, first and second pawls 30 are received in compartment 22 and each have a structure substantially the same as that of pawl 30 of FIGS. 1-6 and 9-10. Furthermore, in addition to first pin 34 extending through first pivot holes 25 of drive member 20 and pin hole 33 of first pawl 30, a second pin 34 is extended through second pivot holes 25 of drive member 20 and pin hole 33 of second pawl 30 and defines a second pivot axis about which second pawl 30 is pivotable.

In the preferred forms shown in FIGS. 1-13, the ratchet wrench further includes a switching device 40 including a control member 41 and a switch member 42. Control member 41 includes a larger section 414 and a smaller section 416 having a diameter smaller than larger section 414. A non-circular engaging portion 411 is formed on an end of larger section 414 distant to smaller section 416. Engaging portion 411 has a diameter larger than larger section 414 and is hexagonal in cross section and has six faces 418 extending in the thickness direction in the preferred forms shown in FIGS. 1-13. Larger section 414 includes a radial hole 413 extending in a radial direction perpendicular to the thickness direction. In the preferred form shown in FIGS. 1-6 and 9-10, radial hole 413 is a blind hole. In the preferred form shown in FIGS. 7-8 and 11-13, radial hole 413 is a through-hole.

In the preferred forms shown in FIGS. 1-13, a recessed portion 412 in the form of a stepped groove is formed on an end of smaller section 416 distant to larger section 414 and spaced from engaging portion 411 in the thickness direction and includes a deeper section and a shallower section. A ball 44 is received in transverse hole 26 of drive member 20 and recessed portion 412 of control member 41. Ball 44 is normally biased by a bottom wall of the shallower section of recessed portion 412 to a position partially beyond transverse hole 26 for coupling with a socket.

In the preferred forms shown in FIGS. 1-13, switch member 42 includes inner and outer sides 427 and 429 spaced in the thickness direction and a non-circular engaging hole 421 extending from a center of inner side 427 through a center of outer side 429. Engaging hole 421 includes a plurality of surfaces 430 extending in the thickness direction and is hexagonal in cross section in the preferred forms shown in FIGS. 1-13. Switch member 42 further includes a recess 428 in inner side 427, forming a peripheral wall 420 having an outer diameter larger than through-hole 13 of head 11. An anti-slipping section 422 is formed on an outer periphery of peripheral wall 420. Furthermore, a groove 423 is defined in an inner periphery of peripheral wall 420. Peripheral wall 420 further includes a notch 424 in communication with groove 423 and defined by two end faces 432. In the preferred form shown in FIGS. 1-13, switch member 42 further includes first and second positioning groove 96 and 98 formed in a bottom wall of recess 428.

In the preferred forms shown in FIGS. 1-13, a retainer ring 425 is received in groove 423 of switch member 42 and in annular groove 21 of drive member 20 and includes two tangs 426 received in notch 424 and abutting end faces 432. Thus, switch member 42 is rotatably mounted around first end 54 of drive member 20. Inner side 427 of peripheral wall 420 of switch member 42 rotatably abuts first side 18 of head 11, and flange 27 of drive member 20 rotatably abuts second side 19 of head 11, preventing disengagement of drive member 20 from head 11. Engaging portion 411 of control member 41 is normally engaged in engaging hole 421 of switch member 42 with faces 418 of engaging portion 411 slideably abutting surfaces 430 of engaging hole 421, allowing joint rotation of control member 41 and switch member 42 relative to drive member 20 while allowing movement of control member 41 relative to switch member 42 and drive member 20 in the thickness direction.

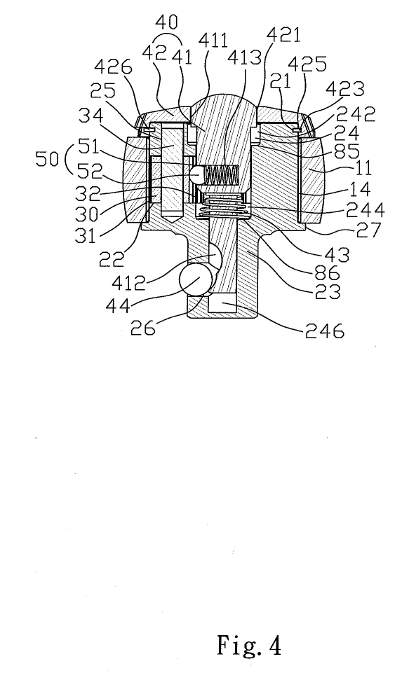

In the preferred forms shown in FIGS. 1-13, control member 41 is pivotably extended through hole 24 of drive member 20, with smaller section 416 received in third section 246 of hole 24, and with larger section 414 received in second section 244 of hole 24. A spring 43 is mounted between an end face of larger section 414 and second stepped portion 86 of hole 24. Spring 43 biases control member 41 to a coupling position such that ball 44 is partially pushed out of hole 26 by the bottom wall of the shallower section of recessed portion 412 (FIG. 4), allowing secure coupling between drive column 23 and a socket. Note that engaging portion 411 of control member 41 is engaged in engaging hole 421 of switch member 42 when control member 41 is in the coupling position.

In the preferred forms shown in FIGS. 1-13, the ratchet wrench further includes a pressing device 50 for retaining pawl 30 in place. Pressing device 50 is mounted in radial hole 413 of control member 41. In the preferred form shown in FIGS. 1-6 and 9-10, pressing device 50 includes a pressing member 52 in the form shown as a ball and an elastic element 51 in the form shown as a spring. Elastic element 51 biases pressing member 52 to partially protrude out of radial hole 413 to press against positioning section 32 of pawl 30. In the preferred form shown in FIGS. 7-8 and 11-13, pressing device 50 includes first and second pressing members 52 in the form shown as two balls and an elastic element 51 in the form shown as a spring. Elastic element 51 biases first and second pressing members 52 to partially protrude out of radial hole 413 to press against pressing sections 32 of first and second pawls 30.

Now that the basic construction of the ratchet wrench of the preferred teachings of the present invention has been explained, the operation and some of the advantages of the ratchet wrench can be set forth and appreciated. In the preferred form shown in FIGS. 1-13, control member 41 can be pivoted relative to drive member 20 between first and second operative positions by manually rotating switch member 41.

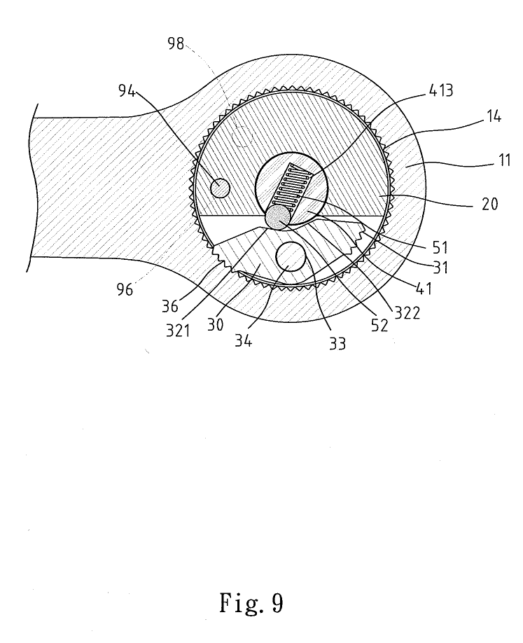

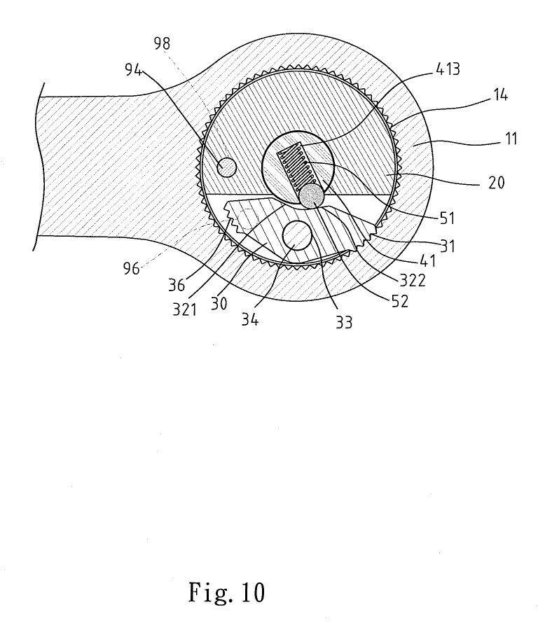

In the preferred form shown in FIGS. 1-6 and 9-10, when control member 41 is in the first operative position (FIG. 9), ball 94 is biased by spring 92 into first positioning groove 96 of switch member 42, and pressing member 52 presses against first positioning face 321 of pawl 30 under the action of elastic element 51. First teeth 31 of pawl 30 are disengaged from teeth 14 of head 11, and second teeth 36 of pawl 30 are engaged with teeth 14 of head 11. In this state, handle 12 and drive member 20 can rotate in the counterclockwise direction to drive a fastener in the counterclockwise direction. Furthermore, handle 12 can rotate freely relative to drive member 20 in the clockwise direction without driving the fastener. When the control member 41 is in the second operative position (FIG. 10), ball 94 is biased by spring 92 into second positioning groove 98 of switch member 42, and pressing member 52 presses against second positioning face 322 of pawl 30. First teeth 31 of pawl 30 are engaged with teeth 14 of head 11. Furthermore, second teeth 36 of pawl 30 are disengaged from teeth 14 of head 11. In this state, handle 12 and drive member 20 can rotate in the clockwise direction to drive the fastener in the clockwise direction. Furthermore, handle 12 can rotate freely relative to drive member 20 in the counterclockwise direction without driving the fastener.

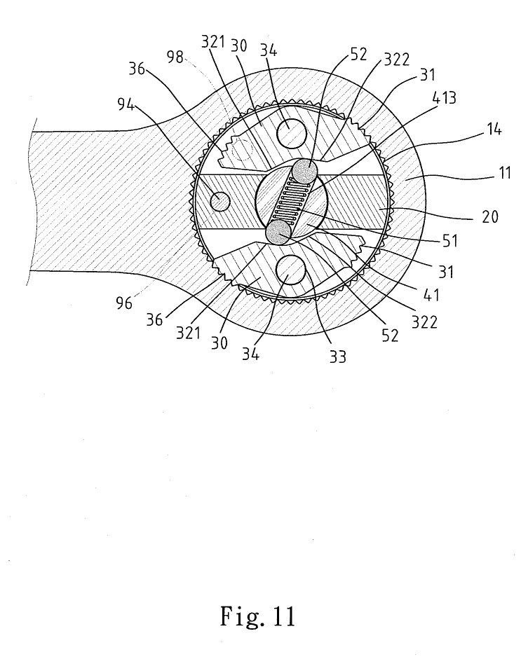

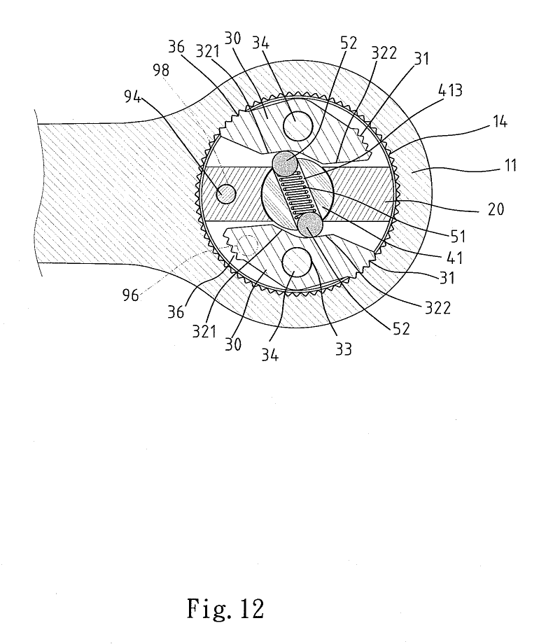

In the preferred form shown in FIGS. 7-8 and 11-13, when control member 41 is in the first operative position (FIG. 11), ball 94 is biased by spring 92 into first positioning groove 96 of switch member 42. First pressing member 52 presses against first positioning face 321 of first pawl 30, and second pressing member 52 presses against second pressing face 322 of second pawl 30. First teeth 31 of first pawl 30 and second teeth 36 of second pawl 30 are disengaged from teeth 14 of head 11. Furthermore, second teeth 36 of first pawl 30 and first teeth 31 of second pawl 30 are engaged with teeth 14 of head 11. In this state, handle 12 and drive member 20 can rotate in the counterclockwise direction to drive the fastener in the counterclockwise direction. Furthermore, handle 12 can rotate freely relative to drive member 20 in the clockwise direction without driving the fastener. When control member 40 is in the second operative position (FIG. 12), ball 94 is biased by spring 92 into second positioning groove 98 of switch member 42. First pressing member 52 presses against second positioning face 322 of first pawl 30, and second pressing member 52 presses against first pressing face 321 of second pawl 30. First teeth 31 of first pawl 30 and second teeth 36 of second pawl 30 are engaged with teeth 14 of head 11. Furthermore, second teeth 36 of first pawl 30 and first teeth 31 of second pawl 30 are disengaged from teeth 14 of head 11. In this state, handle 12 and drive member 20 can rotate in the clockwise direction to drive the fastener in the clockwise direction. Furthermore, handle 12 can rotate freely relative to drive member 20 in the counterclockwise direction without driving the fastener.

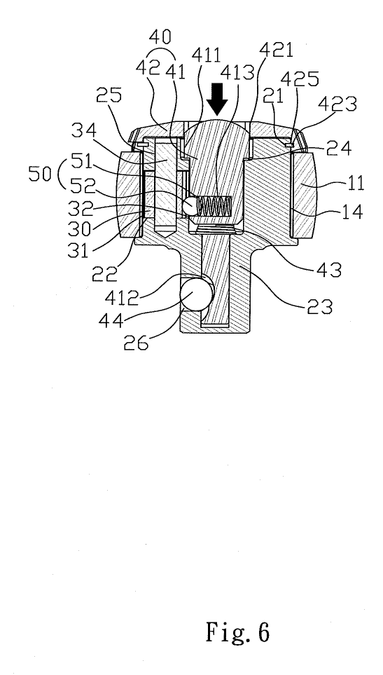

In the preferred forms shown in FIGS. 1-13, when control member 41 is pressed in the thickness direction towards drive column 23 to a release position, spring 43 is compressed, and ball 44 can be received in the deeper section of recessed portion 412 (FIG. 6), allowing disengagement of the socket from drive column 23. It can be appreciated that switch member 42 does not move while control member 41 is moving in the thickness direction. When using the ratchet wrench in a small space, switch member 42 does not move in the thickness direction even if it is inadvertently impinged. Thus, undesired disengagement of the socket from the drive column 23 is avoided. Furthermore, switch member 42 and control member 41 can be easily manufactured separately, reducing the manufacturing costs while providing stronger structural strength and avoiding stress concentration problems encountered in conventional ratchet wrenches with a push rod.

Now that the basic teachings of the present invention have been explained, many extensions and variations will be obvious to one having ordinary skill in the art. For example, although the ratchet wrenches shown in the preferred forms include only two operative positions, the structures of pawls 30 can be modified to provide a third operative position intermediate the first and second operative positions. As an example, when the ratchet wrench of FIGS. 7-8 and 11-13 in the third operative position, first teeth 31 of first and second pawls 30 are engaged with teeth 14 of head 11 while second teeth 36 of first and second pawls 30 are disengaged from teeth 14 of head 11, allowing handle 12 and drive member 20 to rotate jointly in the same direction and preventing handle 12 to rotate in a reverse direction relative to drive member 20. This allows a user to proceed with slight adjustment of tightness of the fastener.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A ratchet wrench comprising, in combination:
a head (11) and a handle (12) interconnected to the head (11), with the head (11) including first and second sides (18, 19) spaced in a thickness direction, with the head (11) further including a through-hole (13) extending from the first side (18) through the second side (19), with the through-hole (13) including an inner periphery having a plurality of teeth (14);
a drive member (20) rotatably received in the through-hole (13), with the drive member (20) including first and second ends (54, 56) spaced in the thickness direction, with the first end (54) of the drive member (20) including a first compartment (22), with the drive member (20) further including a hole (24) extending in the thickness direction and in communication with the first compartment (22), with the second end (56) of the drive member (20) including a transverse hole (26) extending in a radial direction perpendicular to the thickness direction and receiving a first ball (44) adapted for coupling with a socket;
a first pawl (30) pivotably received in the first compartment (22) about a first pivot axis, with the first pawl (30) including first and second ends (60, 62) and an inner side (64) extending between the first and second ends (60, 62) in a longitudinal direction perpendicular to the thickness direction, with the first end (60) of the first pawl (30) including a plurality of first teeth (31), with the second end (62) of the first pawl (30) including a plurality of second teeth (36), with the inner side (64) of the first pawl (30) including first and second positioning faces (321, 322);
a switch member (42) rotatably mounted to the first end (54) of the drive member (20), with the switch member (42) including an engaging hole (421);
a control member (41) rotatably received in through the hole (24) of the drive member (20) between first and second operative positions, with the control member (41) movable in the thickness direction relative to the switch member (42) and the drive member (20) between a coupling position and a release position, with a first spring (43) mounted between the control member (41) and the drive member (20) to bias the control member (41) to the coupling position, with the control member (41) including a first end having an engaging portion (411), with the control member (41) further including a second end having a recessed portion (412) spaced from the engaging portion (411) in the thickness direction, with the recessed portion (412) receiving the first ball (44); and
a pressing device (50) mounted in the control member (41) and including an elastic element (51) and a first pressing member (52) biased by the elastic element (51) to press against one of the first and second positioning faces (321, 322) of the first pawl (30) with the plurality of first teeth (31) or the plurality of second teeth (36) engaged with the plurality of teeth (14) of the head (11) corresponding to the first and second operative positions of the control member (41),
wherein when the control member (41) is in the coupling position, the engaging portion (411) of the control member (41) is engaged in the engaging hole (421) of the switch member (42) allowing joint rotation of the switch member (42) and the control member (41) relative to the drive member (20) between the first and second operative positions, and the first ball (44) is biased by the recessed portion (412) to protrude out of the transverse hole (26) for coupling with the socket, and
wherein when the control member (41) is in the release position, the first ball (44) is movable in the radial direction into the recessed portion (412), allowing removal of the socket from the second end (56) of the drive member (20).

2. The ratchet wrench as claimed in claim 1, with the switch member (42) including inner and outer sides (427, 429) spaced in the thickness direction, with the engaging hole (421) extending from the inner side (427) through the outer side (429), with the switch member (42) further including a recess (428) in the inner side (427), forming a peripheral wall (420) having an outer diameter larger than the through-hole (13) of the head (11), and with the inner side (427) of the peripheral wall (420) rotatably abutting the first side (18) of the head (11).

3. The ratchet wrench as claimed in claim 2, with the first end (54) of the drive member (20) including an annular groove (21) in an outer periphery thereof, with the peripheral wall (420) of the switch member (42) further including an inner periphery having a groove (423), with the peripheral wall (420) further including a notch (424) having two end faces (432) and in communication with the groove (423) of the switch member (42), with the ratchet wrench further comprising, in combination: a retainer ring (425) received in the groove (423) of the switch member (42) and in the annular groove (21) of the drive member (20), with the retainer ring (425) including two tangs (426) received in the notch (424) of the peripheral wall (420) and abutting the two end faces (432) of the notch (424).

4. The ratchet wrench as claimed in claim 3, with the engaging hole (421) of the switch member (42) being non-circular in cross section and including a plurality of surfaces (430) extending in the thickness direction, with the engaging portion (411) of the control member (41) being non-circular in cross section and including a plurality of faces (418) slideably abutting the plurality of surfaces (430) of the switch member (42) in the thickness direction.

5. The ratchet wrench as claimed in claim 3, with the control member (41) including a radial hole (413) extending in a radial direction perpendicular to the thickness direction, with the elastic element (51) and the first pressing member (52) received in the radial hole (413).

6. The ratchet wrench as claimed in claim 5, with the first end (54) of the drive member (20) including first and second boards (70, 72) spaced in the thickness direction and an interconnecting wall (74) interconnected between the first and second boards (70, 72), with the first compartment (22) defined between the first and second boards (70, 72), with the first and second boards (70, 72) including aligned first pivot holes (25), with the first pawl (30) including a first pin hole (33) aligned with the two first pivot holes (25), and with a first pin (34) extending through the first pin hole (33) and the two first pivot holes (25) and defining the first pivot axis.

7. The ratchet wrench as claimed in claim 6, with the first board (70) including the annular groove (21) receiving the retainer ring (425), with the second board (72) including a flange (27) on an outer periphery thereof, and with the flange (27) rotatably abutting the second side (19) of the head (11).

8. The ratchet wrench as claimed in claim 7, with the drive member (20) further including a receptacle (90) extending in the thickness direction through the first board (70) into the interconnecting wall (74), with the recess (428) of the switch member (42) including a bottom wall having first and second positioning grooves (96, 98), with a second spring (92) and a second ball (94) being received in the receptacle (90), with the second ball (94) biased by the second spring (92) into one of the first and second positioning grooves (96, 98) of the switch member (42) corresponding to the first and second operative positions of the control member (41).

9. The ratchet wrench as claimed in claim 8, with the first and second boards (70, 72) including two aligned second pivot holes (25) diametrically opposite to the two first pivot holes (25), with the drive member (20) further including a second compartment (22) between the first and second boards (70, 72) and in communication with the hole (24) of the drive member (20), with the ratchet wrench further comprising, in combination: a second pawl (30) pivotably received in the second compartment (22) about a second pivot axis, with the second pawl (30) including first and second ends (60, 62) and an inner side (64) extending between the first and second ends (60, 62) in the longitudinal direction perpendicular to the thickness direction, with the first end (60) of the second pawl (30) including a plurality of third teeth (31), with the second end (62) of the second pawl (30) including a plurality of fourth teeth (36), with the inner side (64) of the second pawl (30) including third and fourth positioning faces (321, 322), with the second pawl (30) further including a second pin hole (33) aligned with the two second pivot holes (25), with a second pin (34) extending through the second pin hole (33) and the two second pivot holes (25) and defining the second pivot axis, with the plurality of third teeth (31) or the plurality of fourth teeth (36) of the second pawl (30) engaged with the plurality of teeth (14) of the head (11) corresponding to the first and second operative positions of the control member (41).

10. The ratchet wrench as claimed in claim 9, with the radial hole (413) being a through-hole, with the pressing device (50) further including a second pressing member (52) received in the radial hole (413), with the elastic element (51) mounted between the first and second pressing members (52), and with each of the first and second pressing members (52) being biased by the elastic element (51) to press against one of the first and second positioning faces (321, 322) of one of the first and second pawls (30) corresponding to one of the first and second operative positions of the control member (41).
